(19) United States
(12) Patent Application Publication
(10) Pub. No.: US 2008/0161441 A1
(43) Pub. Date: Jul. 3, 2008

(54) Rigid polyurethane/polyisocyanurate castor oil based foams

(76) Inventors: Lance Wang, Parker, CO (US); Julian Eugene Duerr, Littleton, CO (US)

Correspondence Address: JOHNS MANVILLE, 10100 WEST UTE AVENUE, PO BOX 625005, LITTLETON, CO, 80162-5005, US

(21) Appl. No.: 11/646,007

(22) Filed: Dec. 27, 2006

(51) Int. Cl. C08G 18/00; E04B 1/62

(52) U.S. Cl. 521/174; 156/331.4; 52/309.4; 52/746.11

(57) ABSTRACT

Provided by the present invention is a rigid polyurethane/polyisocyanurate foam board product. The board product is comprised of a castor oil based rigid polyurethane/polyisocyanurate foam. Preferably, the board product is based on a polyol mixture of a highly functional castor oil and a polyester and/or polyether polyol.

### BACKGROUND OF THE INVENTION

1. Field of the Invention

The present invention relates to a novel product and process for manufacturing products comprising a rigid polyurethane/polyisocyanurate foam. More specifically, the present invention relates to high bio-containing rigid polyurethane/polyisocyanurate foam products exhibiting good mechanical and thermal properties.

2. Description of the Related Art

The manufacture of flexible faced, rigid polyisocyanurate foam insulation boardstock is commonly practiced by a process called restrained rise lamination. The restrained rise process relies on a combination of chemical component blending, precision metering, reactive component mixing and dispensing, use of a moving opposed platen pressure laminator, and use of dimensioning finishing equipment.

In the traditional restrained rise process, isocyanate (“Component A”) is used as received. Component A is supplied by pump to a metering unit, or a metering pump. A premix (“Component B”) containing polyol, expansion agent, catalyst and surfactant is prepared according to a defined formulation in a mix tank. Component B is also supplied by pump to a metering unit, or a metering pump. The metering pumps boost the pressure generally to 2000 to 2500 psi and control the flow of Components A and B to a precise ratio as determined by the desired chemistry. The pumps deliver Components A and B to at least one foam mixhead. Inside the mixhead, the Components A and B are impinged against each other at high pressure, which results in intimate mixing of the components.

The mixed chemicals exit the mixhead and are dispensed onto a moving bottom facing sheet in a plurality of discrete, liquid streams, in a quantity depending on the type and thickness of desired final boardstock product. The facing sheet carrying the chemical streams then enters a pressure laminator. The spacing, or gap, between the top and bottom platens of the laminator is set to approximately the final desired thickness of boardstock. The laminator temperature is adjusted typically to about 120 to 150° F. to insure that no heat is lost from the reacting, exothermic chemical mix, and to insure that the facings adhere well to the rising foam.

The mixed chemicals begin to react in about 5 to 10 seconds following mixing, expanding about 35 to 40 times in volume in the laminator and completing reaction in about 35 to 45 seconds. Laminator speed is adjusted to insure that complete reaction occurs within the pressure section of the laminator. The reaction rate is adjusted by catalyst modification to optimize chemical mixture “flow.” Flow is a property of the reacting, rising foam by which expansion is controlled in such a manner that the foam properly expands both upward and sideways to fully fill the moving cavity defined by the laminator. This reactivity adjustment is essential to control both the overall properties of the final product and the cost of manufacture. Improper flow results in poor foam cell geometry which can deteriorate physical, thermal and flammability properties, and causes excessive densification of foam layers in contact with facings.

Rigid boardstock, with facing firmly attached, exits the laminator. This boardstock is trimmed to the desired final width and length. Finished product is conveyed to packaging equipment. See also U.S. Pat. Nos. 6,355,701 and 6,140,383 for descriptions of processes using a restrained rise laminator.

Another known process for making flexible faced, rigid polyisocyanurate foam insulation boardstock is the free rise process. In this process, chemical laydown or distribution is accomplished through the use of a pair of matched, precision metering rolls. Chemicals are dispensed just upstream of the metering rolls. The gap between the rolls is adjusted to approximately 1/35 to 1/40 of the desired finished thickness of the boardstock. This small gap causes the dispensed chemical to form a “chemical bank” against the metering roll, forcing the chemical to spread across the full width of the bottom facer. A thin layer of mixed foam chemicals (approximately 1/35 to 1/40 of the desired finished thickness of the boardstock) is uniformly spread between the top and bottom facers. This composite then moves into a heated oven where the foam reaction is completed. Foam expands 35 to 40 times in volume and becomes sufficiently rigid for further processing. Final foam thickness is controlled by precision adjustment of the metering rolls. No mechanical restraint is utilized for thickness control, as with the restrained-rise process.

Although the free rise process presents several significant advantages over the restrained rise process, there are some deficiencies of the free rise process that preclude its use for roof insulation boardstock manufacture. Since the free rise process does not utilize a mechanical means to control product thickness but instead relies on precision metering of chemicals and consistent expansion ratio, thickness variability becomes increasingly exaggerated as overall boardstock thickness is increased, resulting in boardstock that is unacceptable for field application. For example, thickness variation in a 4 inch product can easily be ±0.25 inches, which is unacceptable for many applications. Additionally, typical roof insulation facers are not uniform enough in thickness to provide precision surfaces in the metering roll process. Facer thickness variations will be exaggerated by 35 to 40 times in the final board. Lastly, the free rise process does not employ a mechanical means of foam width formation resulting in excessive waste through edge trim losses. These losses increase as the product thickness increases.

Over the past 20 years, people have tested using vegetable oil as a polyol source for rigid polyurethane/polyisocyanurate (PUR/PIR) foam without any commercial success. Many vegetable oil based polyols cannot even form stable foam in the existing formulation, i.e., the foam collapses or forms very coarse structure. For the polyols that do form stable foam, they usually render inferior foam properties compared to the commercial polyols. The main weaknesses for rigid PUR/PIR foam made with vegetable polyol, especially soy oil based polyol, are low compressive strength and inferior fire resistance. The high percentage of saturated fatty acid chain (about 15% for soy oil based polyol) is theorized to be the cause of low mechanical strength since it acts as a tangling sol in the crosslinked network. In addition, depending on the synthetic route, the vegetable oil based polyol usually shows a much lower reactivity profile than a commercial aromatic polyester polyol, which contains a terminal primary hydroxyl group.

The industry is searching for a rigid polyurethane/polyisocyanate foam product which has a high bio-content, but also exhibits good mechanical and physical properties. It is an objective of the present invention to provide such a rigid foam.

### SUMMARY OF THE INVENTION

The present invention relates to a board product comprising a castor oil based rigid polyisocyanurate foam. In a preferred embodiment, the board product is comprised of a rigid polyurethane/polyisocyanurate foam based on a polyol mixture of a highly functional castor oil and a polyester and/or polyether polyol. The rigid foam has a high bio-content, but also exhibits excellent physical and mechanical properties.

### BRIEF DESCRIPTION OF THE DRAWING FIGURES

FIG. 1 graphically depicts the strength index of various foams.

FIG. 2 graphically depicts the dimension change of various foams relative to temperature.

### DETAILED DESCRIPTION OF THE PREFERRED EMBODIMENTS

Any aggregate isocyanate can be used to prepare the foam product of the present invention, and are often commercially available. Preferred isocyanates used according to the present invention include those commercially available, such as Mondur 489 (Bayer), Rubinate 1850 (ICI), Luprinate M70R (BASF) and Papi 580 (Dow). Isocyanate indices greater than about 200 are preferred, particularly from about 225 to about 325.

In addition to the polyisocyanate, the foam-forming formulation also contains an organic compound containing at least 1.8 or more isocyanate-reactive groups per molecule. Preferred isocyanate-reactive compounds are the polyester and polyether polyols. Such polyester and polyether polyols are described, for example, in U.S. Pat. No. 4,795,763, which is hereby incorporated by reference in its entirety.

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonlic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally may include: substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include: ethylene glycol; propylene glycol-(1,2) and -(1,3); butylene glycol-(1,4) and -(2,3); hexanediol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and those available from Hoechst Celanese. Preferred amounts of the polyester polyols are consistent with isocyanate indices greater than 200, preferably between about 225 and 325. An aromatic polyester polyol is most preferred because it has been found to provide the best balance of rigidity and flame resistance.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

An important aspect of the present invention is the use of bio-content, up to 15% by weight. The bio-content is achieved by using castor oil in a mixture with the polyol. The weight ratio of polyol to castor oil is preferably about 1:1, preferred for its high bio-content. However, good results are achieved for rates of up to 10:1, with 5:1 being preferred and about 1:1 being most preferred. The castor oil used is modified to be a highly functional castor oil. Using basic castor oil, as in using soy oil, generally results in unacceptable soft foams. It has been found that by modifying the castor oil to increase its functionality to at least 4, or higher, a good rigid foam is obtained with high bio-content. Thus, the castor oil employed in the preparation of the rigid foam of the present invention is modified to be a highly functional castor oil, i.e., having a functionality of at least 4.

Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons such as chlorinated and fluorinated hydrocarbons. Suitable blowing agents include HCFC-141b (1-chloro-1,1-difluoroethane), HCFC-22 (monochlorodifluoromethane), HFC-245fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2(2-chloropropane), trichlorofluoromethane, CCI₂ FCCIF₂, CCI₂ FCHF₂, trifluorochloropropane, 1-fluoro-1,1-dichloroethane, 1,1,1-trifluoro-2,2-dichloroethane, metlhylene chloride, diethylether, isopropyl ether, methyl formate, carbon dioxide and mixtures thereof. The pentane blowing agents are most preferred.

The foams also can be produced using a froth-foaming method, such as the one disclosed in U.S. Pat. No. 4,572,865. In this method, the frothing agent can be any material which is inert to the reactive ingredients and is easily vaporized at atmospheric pressure. The frothing agent advantageously has an atmospheric boiling point of −50° to 10° C., and includes carbon dioxide, dichlorodifluoromethane, monochlorodifluoromethane, trifluoromethane, monochlorotrifluoromethane, monochloropentafluoroethane, vinylfluoride, vinylidenefluoride, 1,1-difluoroethane, 1,1,1-trichlorodifluoroethane, and the like. A higher boiling blowing agent is desirably used in conjunction with the frothing agent. The blowing agent is a gaseous material at the reaction temperature and advantageously has an atmospheric boiling point ranging from about 10° to 80° C. Suitable blowing agents include trichloromonofluoromethane, 1,1,2-trichloro-1,2,2-trifluoroethane, acetone, pentane, and the like. In the froth-foaming method, the foaming agents, e.g., trichlorofluoromethane blowing agent or combined trichlorofluoromethane blowing agent and dichlorodifluoromethane frothing agent, are employed in an amount sufficient to give the resultant cured foam the desired bulk density which is generally between 0.5 and 10, preferably between 1 and 5, and most preferably between 1.5 and 2.5, pounds per cubic foot. The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at subambient temperatures until mixed with the other components. Mixtures of foaming agents can be employed.

Any suitable surfactant can be employed in the foams of this invention, including silicone/ethylene oxide/propylene oxide copolymers. Examples of surfactants useful in the present invention include, among others, polydimetlhylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Other suitable surfactants are those described in U.S. Pat. Nos. 4,365,024 and 4,529,745. Generally, the surfactant comprises from about 0.05 to 10, and preferably from 0.1 to 6, weight percent of the foam-forming composition.

Facings may be added to the rigid foam board, and for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include aluminum foil/kraft paper laminations, bare aluminum foil, paper roof insulation facings, and coated glass fiber mats. A facer, as used herein, may also include oriented strandboard or gypsum, in which case such rigid material is conveyed to the laminator, and foam-forming mixture is preferably applied directly thereon.

The process for preparing the rigid foam is generally carried out in the presence of activators. Examples are tertiary amines or organic metal compounds, in particular, tin compounds. Preferably, the tin compounds are divalent tin salts of fatty acids, e.g., tin dioctoate. When an amine is used, it is preferably used in conjunction with one or more potassium organo salts such as potassium octoate and/or potassium acetate.

The results of rigid polyurethane/polyisocyanurate (PUR/PIR) foam made with various soy oil polyols are shown in Table 1 below:

TABLE 1
Results of rigid PUR/PIR foam made with various soy oil polyols

| | Control | | |
|---|---|---|---|
| | (polyester polyol) | Foam 1* | Foam 2 |
| Density (lb/ft³) | 1.60 | 1.84 | 1.71 |
| Compressive Strength | 38 | 21.1 | 11.9 |
| (pcf) | | | |
| Strength Index | 23.8 | 11.5 | 7.0 |
| (CS/density) | | | |
| TMA (20% Dimension | 520 | 418 | 218 |
| loss temperature, ° C.) | | | |

*Foam 1 used 100% vegetable oil polyol as polyol source.

The foam properties were improved by blending the commercial polyester polyol with soy oil based polyol at various ratios. As a result, the bio-content of the foam was reduced. However, it was found that the performance still could not match the use of only polyester polyol.

This invention relates to making rigid PUR/PIR foam with high bio-content, preferably>12%, using castor oil based polyol, which has low saturated fatty acid chain (around 3%) and intrinsic hydroxyl group. A foam made with castor oil based polyol, for example M365 from CasChem, shows a better mechanical strength and better fire resistance than the soy based polyol, though slightly inferior than a commercial aromatic polyester polyol. The results of rigid PIR foam made with M365 and blends with polyester polyol are shown in Table 2 below:

TABLE 2
Results of rigid PIR foam made with castor oil
and blended polyester polyols

| | | | Foam 4 | Foam 5 |
|---|---|---|---|---|
| | | Foam 3 | (aromatic | (aromatic |
| | | (castor | polyester | polyester |
| | Control | oil | polyol and | polyol and |
| | (polyester | based | castor oil basis | castor oil |
| | polyol only) | M365) | 1:1) | basis 1:1) |
| Density (lb/ft3) | 1.6 | 2.03 | 1.93 | 1.68 |
| Compressive | 38 | 33 | 43.2 | 36.1 |
| Strength (pcf) | | | | |
| Strength Index | 23.8 | 16.3 | 22.4 | 21.5 |
| (CS/density) | | | | |
| TMA (20% | 527 | 298 | 490 | |
| Dimension loss | | | | |
| temperature, ° C.) | | | | |

*Foam 5 was optimized for density and reactivity profile.

The fire resistance and thermal stability as evaluated by Hot Plate and TMA are shown in Table 3 below and in FIG. 2.

TABLE 3
Weight Retention results from Hot Plate Test Method

| | | | | | Foam I |
|---|---|---|---|---|---|
| | | | | | (aromatic |
| | | | | | polyester |
| | | Foam 6 | Foam C | Foam H | polyol |
| | Control | (soy | (vegetable | (castor oil | and castor |
| | (polyester | based | based | based | based polyol |
| | polyol only) | polyol) | polyol) | polyol) | oil) |
| Weight | 82 | 65 | 70 | 82 | 92 |
| Retention | | | | | |
| (%) | | | | | |

As shown in previous Tables and Figures, rigid PIR foam made with castor oil based polyol, e.g., M365, showed good mechanical properties, high thermal stability, and high bio-content, which is novel in the rigid PIR field.

In the following table, Table 4, the control facer peel is very sensitive to temperature but bio-foam (a blend of aromatic based polyol and castor oil based polyol) is not, which is a benefit in light of the use of low laminator temperature in certain plants.

TABLE 4

| | Temperature | | Density | | Facer Peel |
|---|---|---|---|---|---|
| Polyol | (F.) | % Pentane | (lb/ft³) | Comp Str | Strength |
| Control | 180 | 5.84 | 1.80 | 15.33 | 0.635 |
| Bio-Blend | 180 | 4.5 | 2.22 | 20.58 | 1.066 |
| Control | 160 | 5.84 | 1.89 | 18.06 | 0.869 |
| Bio-Blend | 160 | 4.5 | 2.21 | 25.55 | 1.278 |
| Control | 140 | 5.84 | 1.94 | 17.54 | 0.012 |
| Bio-Blend | 140 | 4.5 | 2.21 | 25.55 | 1.412 |

While the invention has been described in detail and with reference to specific embodiments thereof, it will be apparent to one skilled in the art that various changes and modifications can be made therein without departing from the spirit and scope thereof.

What is claimed is:

1. A rigid polyurethane/polyisocyanurate foam comprised of the reaction product of a highly functional castor oil, a polyester polyol and/or polyether polyol, and an isocyanate.

2. The rigid foam of claim 1, wherein the polyester polyol is an aromatic polyester polyol.

3. The rigid foam of claim 2, wherein the reaction product is a reaction product of castor oil, an aromatic polyol and an isocyanate, wherein the castor oil and aromatic polyester polyol are present in a ratio of at least 1:1.

4. The rigid foam of claim 1, wherein the polyether polyol is an alkoxylated polyol.

5. The rigid foam of claim 1, wherein the foam is a reaction product of castor oil, a polyester polyol and an isocyanate, with the ratio of castor oil to polyester polyol being at least 1:1.

6. The rigid foam of claim 1, wherein the foam is a board product.

7. The rigid foam of claim 1, wherein the foam is an insulation layer for a roofing system.

8. A roofing system comprised of a bitumen-based layer and the insulation layer of claim 7.

9. A process for preparing a rigid polyurethane/polyisocyanurate foam comprised of reacting a highly functional castor oil, a polyester polyol and/or polyether polyol, and an isocyanate, and then foaming the reaction product.

10. The process of claim 9, wherein the process comprises reacting the castor oil, a polyester polyol, and an isocyanate, and then foaming the reaction product.

11. The process of claim 10, wherein the polyester polyol is an aromatic polyester polyol.

12. The process of claim 10, wherein the ratio of castor oil to polyester polyol is at least 1:1.

13. The process of claim 11, wherein the ratio of castor oil to aromatic polyester polyol is about 1:1.

14. A process for manufacturing an insulation board comprising a rigid polyurethane/polyisocyanurate foam having two major surfaces and a facing material on at least one of the major surfaces, the method comprising:
a) conveying a facing material along a production line for attachment to one major surface of the foam;
b) applying a foam forming mixture of polyisocyanurate to the facing material in a manner comprising spreading the mixture with a spreading means in the direction of the width of the facing material, with the polyisocyanurate being a reaction product of a highly functional castor oil, a polyester polyol and/or polyether polyol and an isocyanate;
c) optionally conveying a second facing material along the production line for attachment to the other major surface of the foam;
d) conveying the facing material with applied foam forming mixture into a restrained rise laminator which comprises a gap for foam expansion and allowing the mixture to foam and expand to fill the gap within the laminator; and
e) curing the foam, with a catalyst system comprising a polyol.
